(19) United States
(12) Patent Application Publication
(10) Pub. No.: US 2020/0228176 A1
(43) Pub. Date: Jul. 16, 2020

(54) FAST BEAMFORMING IN MULTI-ANTENNA RF CONFIGURATIONS

(71) Applicant: QUALCOMM Incorporated, San Diego, CA (US)

(72) Inventors: Raz BAREKET, Haifa (IL); Amichai SANDEROVICH, Atlit (IL)

(21) Appl. No.: 16/246,054

(22) Filed: Jan. 11, 2019

(51) Int. Cl. H04B 7/06; H04B 7/0408; H04B 7/08; H04L 27/26

(52) U.S. Cl. CPC H04B 7/0617; H04L 27/2626; H04B 7/0837; H04B 7/0408

(57) ABSTRACT

Certain aspects of the present disclosure provide methods and apparatus for fast beamforming in multi-antenna radio frequency (RF) configurations. For example, according to certain aspects, devices may receive one or more reports of one or more beamforming transmit sectors. The devices may generate a list of beamforming transmit sectors based on the one or more reports, wherein the list includes the one or more beamforming transmit sectors that satisfy one or more conditions related to one or more parameters for a partial sector level sweep. The devices may also perform the partial sector level sweep based on the list of beamforming transmit sectors.

### BACKGROUND

### Field of the Disclosure

Certain aspects of the present disclosure generally relate to wireless communications and, more particularly, to fast beamforming in multi-antenna radio frequency (RF) configurations.

### Description of Related Art

In order to address the issue of increasing bandwidth requirements demanded for wireless communications systems, different schemes are being developed to allow multiple user terminals to communicate with a single access point by sharing the channel resources while achieving high data throughputs.

Certain applications, such as virtual reality (VR) and augmented reality (AR) may demand data rates in the range of several Gigabits per second. Certain wireless communications standards, such as the Institute of Electrical and Electronics Engineers (IEEE) 802.11 standard, denote a set of Wireless Local Area Network (WLAN) air interface standards developed by the IEEE 802.11 committee for short-range communications (e.g., tens of meters to a few hundred meters).

Amendment 802.11ad to the WLAN standard defines the MAC and PHY layers for very high throughput (VHT) in the 60 GHz range. Operations in the 60 GHz band allow the use of smaller antennas as compared to lower frequencies. However, as compared to operating in lower frequencies, radio waves around the 60 GHz band have high atmospheric attenuation and are subject to higher levels of absorption by atmospheric gases, rain, objects, and the like, resulting in higher free space loss. The higher free space loss can be compensated for by using many small antennas, for example, arranged in a phased array.

Using a phased array, multiple antennas may be coordinated to form a coherent beam traveling in a desired direction (or beam), referred to as beamforming. An electrical field may be rotated to change this direction. The resulting transmission is polarized based on the electrical field. A receiver may also include antennas which can adapt to match or adapt to changing transmission polarity.

The procedure to adapt the transmit and receive antennas, referred to as beam form training, may be performed initially to establish a link between devices and may also be performed periodically to maintain a quality link using the best transmit and receive beams.

Unfortunately, beamforming training represents a significant amount of overhead, as the training time reduces data throughput. The amount of training time increases as the number of transmit and receive antennas increase, resulting in more beams to evaluate during training.

### BRIEF SUMMARY

Certain aspects of the present disclosure provide an apparatus for wireless communications. The apparatus generally includes a first interface configured to receive one or more reports of one or more beamforming transmit sectors, and a processing system configured to generate a list of beamforming transmit sectors based on the one or more reports, wherein the list includes the one or more beamforming transmit sectors that satisfy one or more conditions related to one or more parameters for a partial sector level sweep, and wherein the first interface and processing system are configured to perform the partial sector level sweep based on the list of beamforming transmit sectors.

Certain aspects of the present disclosure provide a method for wireless communications by a network entity. The method generally includes receiving one or more reports of one or more beamforming transmit sectors, generating a list of beamforming transmit sectors based on the one or more reports, wherein the list includes the one or more beamforming transmit sectors that satisfy one or more conditions related to one or more parameters for a partial sector level sweep, and performing the partial sector level sweep based on the list of beamforming transmit sectors.

Certain aspects of the present disclosure provide an apparatus for wireless communications. The apparatus generally includes mean for receiving one or more reports of one or more beamforming transmit sectors, means for generating a list of beamforming transmit sectors based on the one or more reports, wherein the list includes the one or more beamforming transmit sectors that satisfy one or more conditions related to one or more parameters for a partial sector level sweep, and means for performing the partial sector level sweep based on the list of beamforming transmit sectors.

Certain aspects of the present disclosure provide a wireless station. The wireless station generally includes a transceiver configured to receive one or more reports of one or more beamforming transmit sectors, and a processing system configured to generate a list of beamforming transmit sectors based on the one or more reports, wherein the list includes the one or more beamforming transmit sectors that satisfy one or more conditions related to one or more parameters for a partial sector level sweep, and wherein the transceiver and processing system are further configured to perform the partial sector level sweep based on the list of beamforming transmit sectors.

Certain aspects of the present disclosure provide a non-transitory computer readable medium having instructions stored. The instructions include receiving one or more reports of one or more beamforming transmit sectors, generating a list of beamforming transmit sectors based on the one or more reports, wherein the list includes the one or more beamforming transmit sectors that satisfy one or more conditions related to one or more parameters for a partial sector level sweep, and performing the partial sector level sweep based on the list of beamforming transmit sectors

Aspects of the present disclosure also provide various methods, means, and computer program products corresponding to the apparatuses and operations described above.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point and example user terminals, in accordance with certain aspects of the present disclosure.

FIG. 3 is a diagram illustrating signal propagation in an implementation of phased-array antennas, in accordance with certain aspects of the present disclosure.

FIG. 4 illustrates an example beamforming training procedure, in accordance with certain aspects of the present disclosure.

FIG. 5 illustrates an example beamforming training procedure in which an initiator and responder are in synch, in accordance with certain aspects of the present disclosure.

FIG. 6 illustrates an example beamforming training procedure in which an initiator and responder are out of synch, in accordance with certain aspects of the present disclosure.

FIG. 7 illustrates an example partial sector sweep information element (IE), in accordance with certain aspects of the present disclosure.

FIG. 8 illustrates a table that defines the meaning of each field of a partial sector sweep information element, in accordance with certain aspects of the present disclosure.

FIG. 9 illustrates an example beamforming training procedure, in accordance with certain aspects of the present disclosure.

FIG. 10 illustrates example operations for performing wireless communication, in accordance with certain aspects of the present disclosure.

FIG. 11 illustrates example components capable of performing operations of FIG. 10, in accordance with certain aspects of the present disclosure.

FIG. 12 illustrates an example of transmitting modules and a receiver, in accordance with certain aspects of the present disclosure.

FIG. 13 illustrates a communications device that may include various components configured to perform operations for the techniques described herein in accordance with certain aspects of the present disclosure.

### DETAILED DESCRIPTION

The development of the 802.11ay standard for 60 GHz communication is an enhancement of the existing 802.11ad (DMG-Directional Multi-Gigabit) standard. The development addresses a number of conditions including, for example, implementing high gain phased array antennas to help address high-frequency issues in order to achieve increased ranges in 60 GHz. To get these high gain antennas to point in the correct direction one or more beamforming training algorithms may be implemented. Currently, in the 802.11ad standard, usage of beamforming training algorithms based on TX sector sweep training may be provided for the case when the two devices do not have a working (control PHY) link. When implementing such training the TX sector sweep may be considered to be a very long operation, for example, when in the case where the arrays have 256/128 elements.

Uses such as Virtual Reality/Augmented Reality (AR/VR) require frequent beamforming training given the propensity of the device to be in motion due to the nature of the usage and implementation parameters. Accordingly, it can be appreciated that in cases where the link degrades or is lost, i.e. there is no control PHY connection, the devices may have to resort to TX sector sweep based on sector sweep packets. Such a sector sweep can be considered to be a relatively long time commitment. The time taken is a factor of having to sweep sector by sector. Further, the time taken can also depend on the number of transmitting modules and on the number of sectors. During this time taken, no data transmissions occur. Accordingly, it can be appreciated that such an arrangement may lead to interruption of service for too long to allow for an overall desired performance metrics to be reached.

In one or more cases and disclosed herein, a select set of sectors may be used as part of the sector sweep which are a subset of all available sectors. This set of sectors may be selected based on a set of TX sectors that were identified as good TX sectors that meet one or more desired conditions related to one or more parameters which were identified and obtained in a previous sector sweep. This smaller select subset set of sectors may be used in the current 802.11ad specification when both devices have a single antenna array. However, issues may arise when one of the devices has multiple Rx antennas. In a case where a device has multiple antennas, the device may have to switch RX antennas and further the device may have to switch RX antennas for every sector sweep the other device uses. To be more effective, the switching rate can be related to the number of sectors used by the other device. Accordingly, the number of sectors can be known in advance. This case arrangement works when such parameters are constant, but it may present with issues when it is dynamical.

Another consideration that may be taken into account is addressing the scenario where none of the sectors in the partial sectors sweep is received by the other side. If none of the sectors in the partial sectors sweep is received by the other side, a switch to a full sector sweep may be triggered and the devices may implement such a sweep together.

In some cases, the TX sectors for a sector level sweep (SLS) may be selected through a series of operations. For example, the operations may include generating an initial list of sectors based on sectors reported by the receiver as having sufficient signal-to-noise ratio (SNR). Further, the list of sectors may be extended by adding sectors known to have spatial coverage which is tangent to the spatial coverage of the sectors in the initial list. The extended list may be consolidated such that each sector is represented only once. Further, the sectors in the list may be graded based on the SNR reported by the receiver and/or relative TX sector gain. The list of sectors may also be ordered based on the grades of the sectors such that the sectors are ordered starting with sectors with a high grade that corresponds to higher SNR values. The resulting list may be used to select up to a pre-defined number of sectors to be used for a partial sector sweep.

In some cases, the procedure may be applied to TX sectors belonging to a single antenna or to TX sectors belonging to adjacent antennas pointed in different directions. In some cases, the procedure may filter out sectors which have low probability of providing sufficient SNR from the Sector Level Sweep (SLS). In some cases, sweeping over a larger number of sectors may be applied from time to time, in full or gradually, to ensure the best sectors are indeed within the list.

Thus, certain aspects of the present disclosure provide methods and apparatus for fast beamforming in multi-antenna RF configurations. By communicating one or more reports of one or more beamforming transmit sectors, an initiator and responder effectively communicate the information that can be used to facilitate fast beamforming in multi-antenna RF configurations. This may further be provided by also generating a list of beamforming transmit sectors based on the one or more reports. The list may include the one or more beamforming transmit sectors that satisfy one or more conditions related to one or more parameters for a partial sector level sweep.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to a different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. The techniques described herein may be utilized in any type of applied to Single Carrier (SC) and SC-MIMO systems.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smartphone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such a wireless node may provide, for example, connectivity for or to a network (e.g., a wide area network such as the Internet or a cellular network) via a wired or wireless communication link.

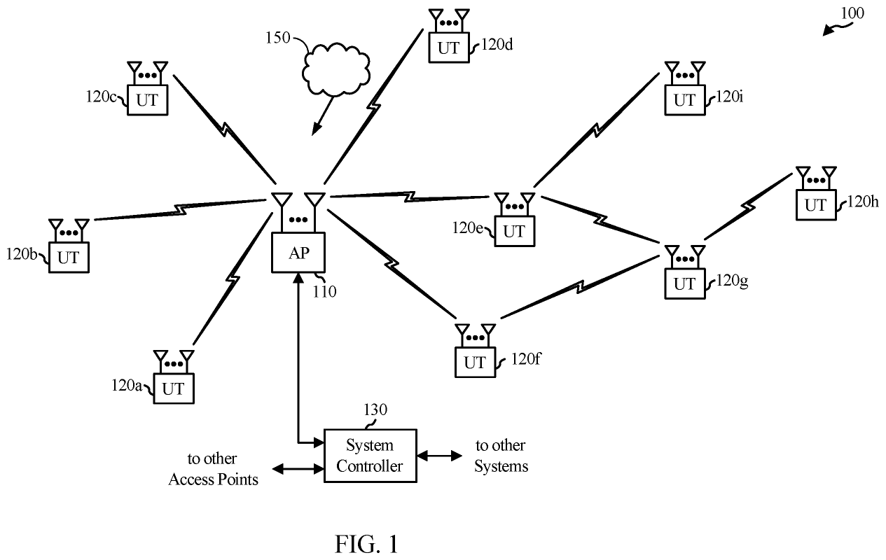

FIG. 1 illustrates a multiple-access multiple-input-multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≤K≤1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≤1). The K selected user terminals can have the same or a different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

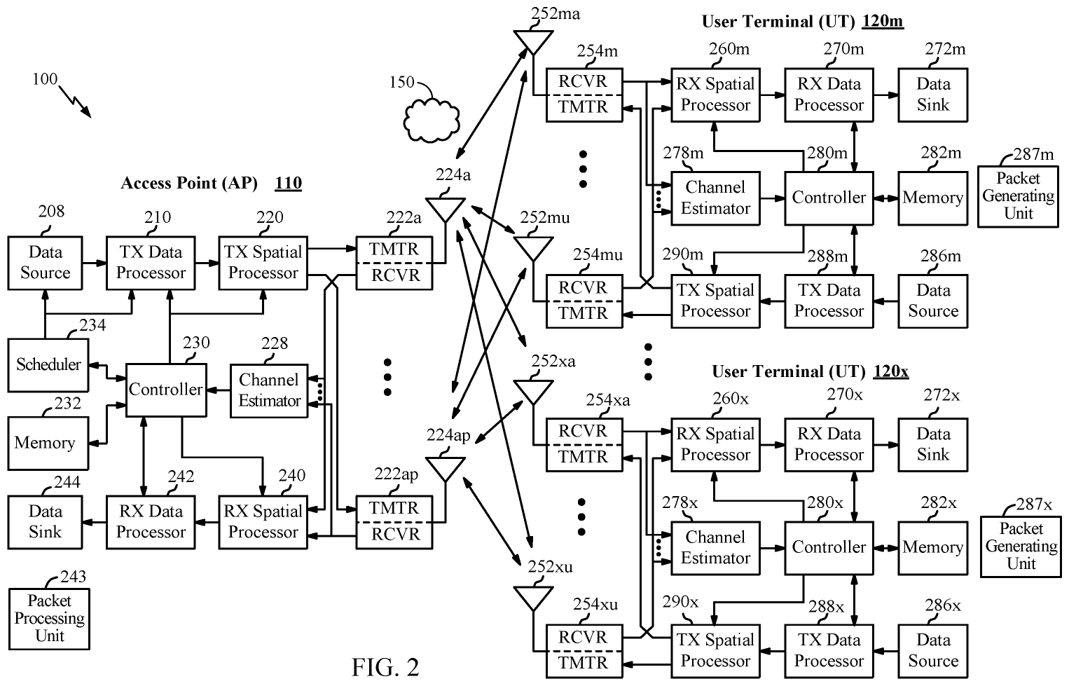

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “dn” denotes the downlink, the subscript “up” denotes the uplink, Nup user terminals are selected for simultaneous transmission on the uplink, Ndn user terminals are selected for simultaneous transmission on the downlink, Nup may or may not be equal to Ndn, and Nup and Ndn may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nup user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nup recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for Ndn user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides Ndn downlink data symbol streams for the Ndn user terminals. A TX spatial processor 220 performs spatial processing (such as a precoding or beamforming, as described in the present disclosure) on the Ndn downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

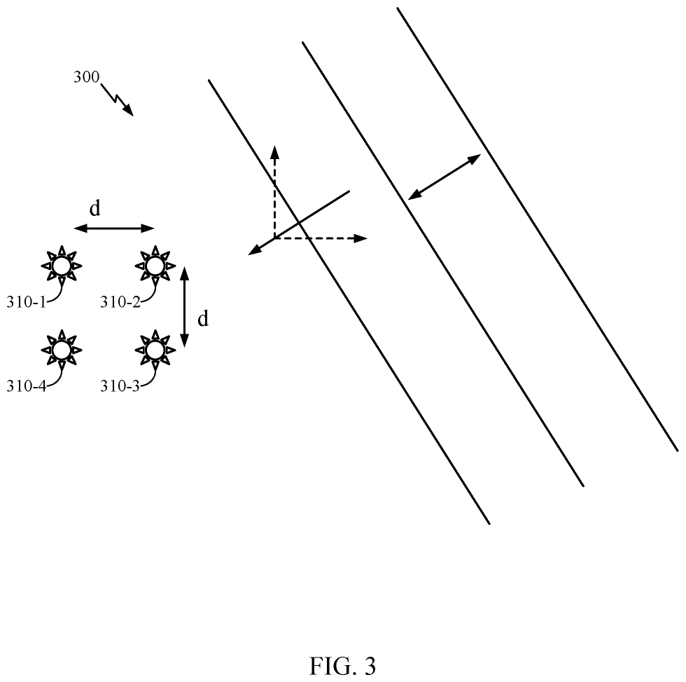

As illustrated, in FIGS. 1 and 2, one or more user terminals 120 may send one or more High-Efficiency WLAN (HEW) packets 150, with a preamble format as described herein (e.g., in accordance with one of the example formats shown in FIGS. 3A-3B), to the access point 110 as part of an uplink (UL) MU-MIMO transmission, for example. Each HEW packet 150 may be transmitted on a set of one or more spatial streams (e.g., up to 4). For certain aspects, the preamble portion of the HEW packet 150 may include tone-interleaved long training fields (LTFs), subband-based LTFs, or hybrid LTFs (e.g., in accordance with one of the example implementations).

The HEW packet 150 may be generated by a packet generating unit 287 at the user terminal 120. The packet generating unit 287 may be implemented in the processing system of the user terminal 120, such as in the TX data processor 288, the controller 280, and/or the data source 286.

After UL transmission, the HEW packet 150 may be processed (e.g., decoded and interpreted) by a packet processing unit 243 at the access point 110. The packet processing unit 243 may be implemented in the process system of the access point 110, such as in the RX spatial processor 240, the RX data processor 242, or the controller 230. The packet processing unit 243 may process received packets differently, based on the packet type (e.g., with which amendment to the IEEE 802.11 standard the received packet complies). For example, the packet processing unit 243 may process a HEW packet 150 based on the IEEE 802.11 HEW standard, but may interpret a legacy packet (e.g., a packet complying with IEEE 802.11a/b/g) in a different manner, according to the standards amendment associated therewith.

Certain standards, such as the IEEE 802.11ay standard currently in the development phase, extend wireless communications according to existing standards (e.g., the 802.11ad standard) into the 60 GHz band. Example features to be included in such standards include channel aggregation and Channel-Bonding (CB). In general, channel aggregation utilizes multiple channels that are kept separate, while channel bonding treats the bandwidth of multiple channels as a single (wideband) channel.

As described above, operations in the 60 GHz band may allow the use of smaller antennas as compared to lower frequencies. While radio waves around the 60 GHz band have relatively high atmospheric attenuation, the higher free space loss can be compensated for by using many small antennas, for example, arranged in a phased array.

Using a phased array, multiple antennas may be coordinated to form a coherent beam traveling in a desired direction. An electrical field may be rotated to change this direction. The resulting transmission is polarized based on the electrical field. A receiver may also include antennas which can adapt to match or adapt to changing transmission polarity.

FIG. 3 is a diagram illustrating signal propagation 300 in an implementation of phased-array antennas. Phased array antennas use identical elements 310-1 through 310-4 (hereinafter referred to individually as an element 310 or collectively as elements 310). The direction in which the signal is propagated yields approximately identical gain for each element 310, while the phases of the elements 310 are different. Signals received by the elements are combined into a coherent beam with the correct gain in the desired direction.

### Beamforming Training Procedure

In high frequency (e.g., mmWave) communication systems like 60 GHz (e.g., 802.11ad and 802.11ay), communication is based on beamforming (BF), using phased arrays on both sides for achieving good link. As described above, beamforming (BF) generally refers to a mechanism used by a pair of STAs to adjust transmit and/or receive antenna settings achieve desired link budget for subsequent communication.

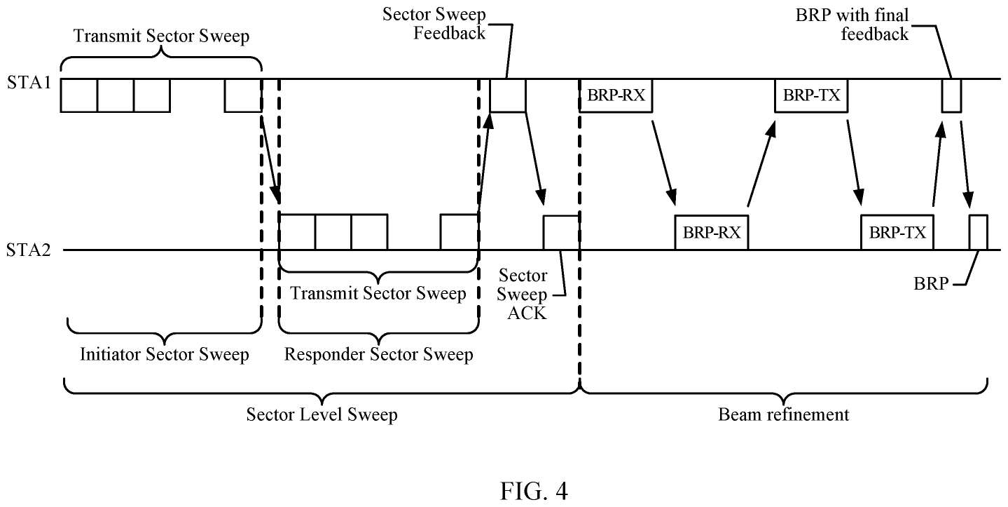

As illustrated in FIG. 4, BF training typically involves a bi-directional sequence of BF training frame transmissions between stations (STA1 and STA2 in this example) that uses a sector sweep followed by a beam refining phase (BRP). For example, an AP or non-AP STA may initiate such a procedure to establish an initial link. During the sector sweep, each transmission is sent using a different sector (covering a directional beam of a certain width) identified in the frame and provides the necessary signaling to allow each STA to determine appropriate antenna system settings for both transmission and reception.

As illustrated in FIG. 4, in scenarios where the AP has a large number of elements, the sectors used are relatively narrow, causing the SLS (Sector Level Sweep) process to be long. The higher the directivity more sectors are needed and therefore the SLS is longer. As an example, an AP with an array of 100 antenna elements may use 100 sectors. This situation is not desired since SLS is an overhead affecting throughput, power consumption and induces a gap in the transport flow.

Various techniques may be used to try and reduce throughput time. For example, short SSW (SSSW) messages may be used instead of the SSW messages, which may save some time (e.g., about 36%). Throughput may be reduced by utilizing the fact that in such APs the transmitter can transmit via several radio frequency (RF) chains. This facilitates transmission in parallel on several single channels. It can shorten the scan by the factor number of frequencies (2 or 3 or 4). Unfortunately, this approach may require the receiver to support the multiple frequencies scan, and it is not backward compatible (e.g., with 802.11ad devices) and requires the stations to fully be aware of this special mode in advance. The Tx SLS+Rx SLS or the Tx SLS+Rx BRP may be replaced with a new Tx+Rx BRP where only one “very” long BRP message is used with many TRN units. Unfortunately, this method requires a very long message but may be able to support multiple STAs in parallel, making it efficient but only in scenarios with a large number of STAs.

### Beamforming Training with Partial Multi-Antenna SLS

As noted above, to achieve increased ranges in high-frequency communications systems (e.g., 60 GHz), devices may have multiple, high gain phased array antennas. Further, to get these high gain antennas to point in the right direction a beamforming training algorithm may be implemented. To train devices with multiple antennas, a transmit sector sweep may be repeated for each transmit antenna array of an initiator and for each receive antenna array of a responder. Such beamforming training algorithms take a significant amount of time, particularly when the arrays are relatively large (e.g., with 256/128 elements). Additionally, uses such as Virtual Reality/Augmented Reality (AR/VR) require frequent beamforming training.

When the link is lost (i.e. there is no control PHY connection) or degrades considerably, the devices have to resort to a TX SLS procedure based on sector sweep packets. A full sector sweep, across all transmit and receive antennas can be very long and interrupts service for too long. Therefore, a partial sector sweep may be performed using a reduced set of sectors. This set may be based, for example, on a set of good TX sectors obtained in a previous sector sweep. For single antenna array devices, a partial sector sweep may be relatively straightforward.

However, a partial sector sweep presents a challenge when one (or both) of the devices have multiple Rx antennas. When a device has multiple antennas, it may have to switch between its RX antennas as the other device repeats each sector sweep. To be effective, the switching rate has to be related to the number of sectors used by the other device. In other words, the number of sectors has to be known in advance so the device can know when one sweep is over and it can switch to a different RX antenna. This may not be a problem if the number of sectors is constant, but it is a problem when it is dynamic. Aspects of the present disclosure may facilitate partial sweeps for multi-antenna devices by providing a flexible mechanism for exchanging information regarding the number of sectors (as well as a number of receive antennas) each device will use in a partial sector sweep.

Another challenge presented when a link degrades or is lost between multi-antenna devices is that if the sector sweep (SSW) frames in the partial sector sweep are not received by the other side, the device may need to switch to a full sector sweep. Obviously, both devices need to switch to the full sector sweep together. Aspects of the present disclosure also provide a timing mechanism that allows an initiator and responder to stay in synch regarding when to start a partial sector sweep after a link failure and when to switch from the partial sector sweep to a full sector sweep.

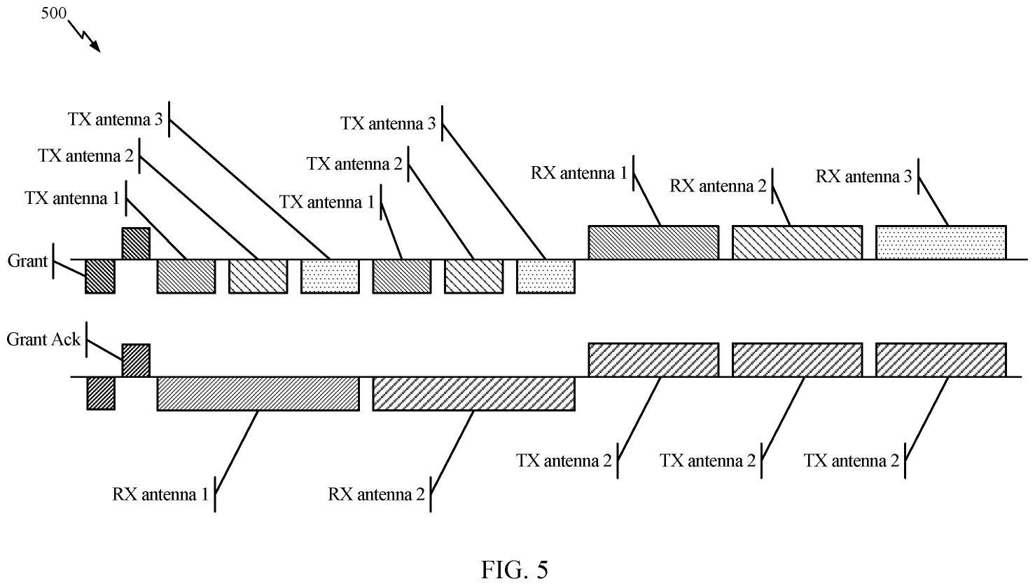

FIG. 5 illustrates an example beamforming training procedure 500 between an initiator (top) and responder (bottom) with multiple antennas. The illustrated example assumes the initiator has 3 TX (and RX) antennas, while the responder has 2 RX (and TX) antennas. As described above, the initiator performs a sector sweep for each of its TX antennas and repeats the same for each of the responder RX antennas. Assuming reciprocity, when training the other direction, the responder may perform a sector sweep transmitting only from the antenna that had the best reception during the initiator sector sweep, but repeats this sweep for all (3) of the initiators Rx antennas.

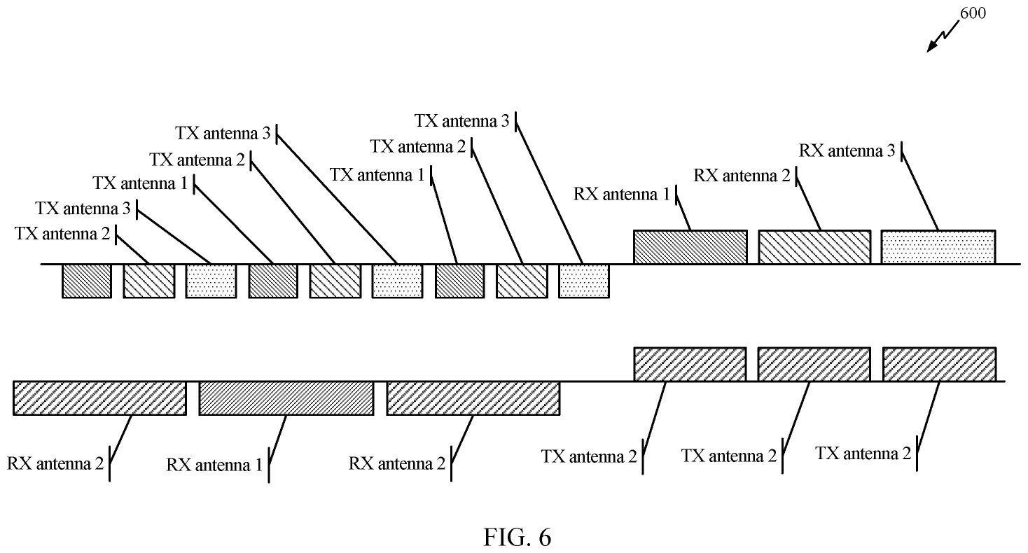

In FIG. 5, the initiator and responder are in synch, meaning the receiving devices are able to switch their RX antennas at the right time (after each TX sector sweep is complete). FIG. 6, on the other hand, illustrates an example beamforming training procedure when the devices are not synchronized. In this example, the responder may not have received the SSW frames in the first initiator sector sweep (and therefore, does not acknowledge that sweep). As a result, the initiator has to repeat that sector sweep, which increases the latency of the beamforming training.

As noted above, however, aspects of the present disclosure may help an initiator and responder to stay in synch regarding when to start a partial sector sweep after a link failure and when to switch from the partial sector sweep to a full sector sweep. Aspects of the present disclosure also provide a mechanism that allows both devices to agree on a number of antennas and the total length of the partial and full sector sweeps.

Operations for performing beamforming training may be separately performed both by an initiator and a responder device. For example, operations may include generating at least one first frame indicating a first number of beamforming transmit sectors for the apparatus to use for a first type of sector sweep procedure (e.g., a partial sector sweep) and a second number of beamforming transmit sectors for the apparatus to use for a second type of sector sweep procedure (e.g., a full sector sweep). The device may further output the first frame for transmission to a wireless node. The device may detect a loss of a communication link established with the wireless node (e.g., based on an expiration of a beamforming maintenance timer that is reset with successful transmissions) and, after the detection, the device may participate in the first type of sector sweep procedure with the wireless node.

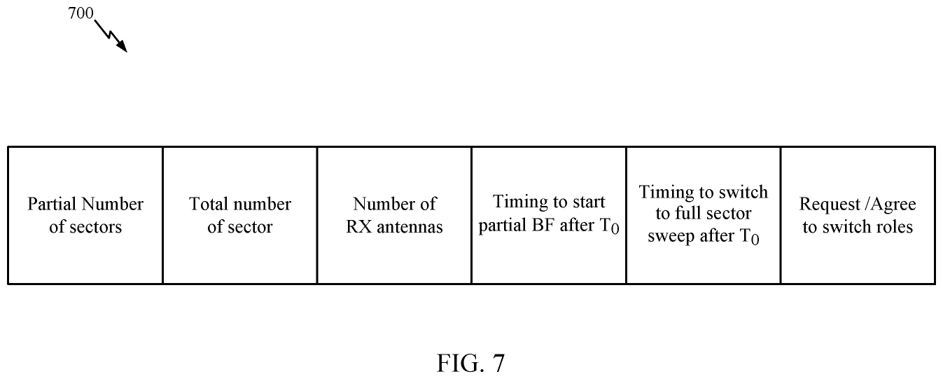

The information regarding the number of beamforming transmit sectors for the partial and full sector sweeps may be provided in an information element (IE). For example, FIG. 7 illustrates an example partial sector sweep IE 700 in accordance with certain aspects of the present disclosure. While shown in a single IE, the information may be included in separate IEs, or otherwise conveyed separately. As shown, IE 700 may include a number of sectors for a partial sector sweep and a total number of sectors for a full sector sweep. The IE may also include the number of Rx antennas. To help devices synchronize partial and/or full sector sweeps after losing a link, IE 700 may also include timing information, such as a time to start partial BF after detecting a degradation or a lost link (e.g., assuming a link is lost at TO, for example, with expiration of a BF maintenance timer), as well as a time to switch to full sector sweep after TO.

The IE may also include a request for a device to switch roles (e.g., from a responder to initiator) or agreement to allow such a request. This may be helpful if it is advantageous for one device to be an initiator, for example, if that device is plugged into power and is able to perform more transmissions. As another example, the overall beamforming training time may be reduced if one device is an initiator (e.g., based on the transmit and receive antenna configurations and/or agreed upon a number of transmit sectors).

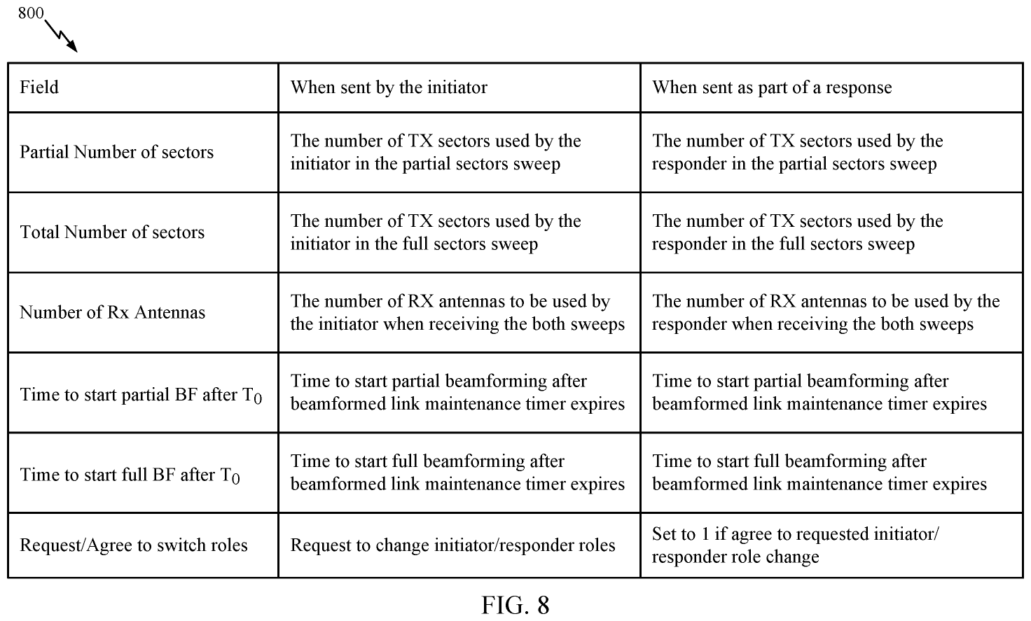

FIG. 8 illustrates a table that defines the meaning of each field in the IE, depending on when the partial sector sweep IE is sent by the initiator or when sent as part of a response. For example, the partial number of sectors, when sent by the initiator, represents the number of TX sectors used by the initiator in the initiator partial sectors sweep. Alternatively, when sent by a responder, the partial number of sectors may represent the number of TX sectors used by the responder in the responder partial sectors sweep.

The IE may be exchanged in any management action frame. The IE may be included in BRP frames. For example, the IE may be sent by either the initiator of the last beamforming training or the responder of the last beamforming training. This timing makes sense, because after such training the number of good sectors (that might form the basis of a partial sector sweep) may be known. After receiving the IE, a device may respond by sending its own IE.

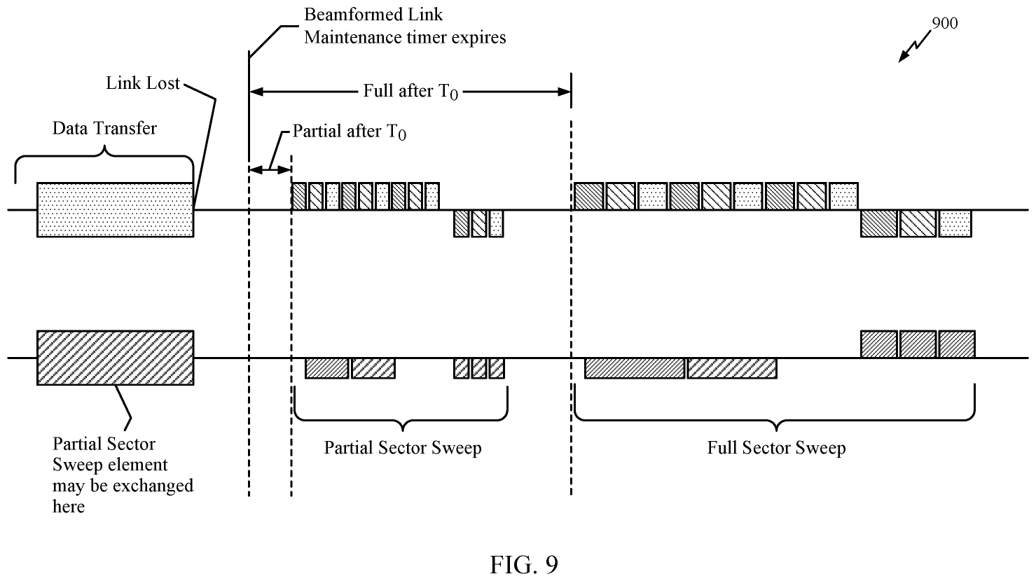

FIG. 9 illustrates an example beamforming training procedure in accordance with certain aspects of the present disclosure, utilizing the timing mechanism described above to initiate partial and/or full sector sweeps after losing a link.

The timeline of FIG. 9 assumes that previously (e.g., during data transfer or in some BF process) the partial sector sweep information element is exchanged. At some point, the link degrades or is lost (e.g., due to a blocker, or due to turning/re-orienting of one of the devices). After the link degrades or is lost, a beamformed link maintenance timer (e.g., see clause 11.29 in standard 802.11-2016) may expire (corresponding to reference time T0 referenced in table 9—although the timing of the expiration of this timer may not be perfectly in synch between the two devices). Now the timing information exchanged may be used to synchronize both devices to try and restore the degraded or lost link.

For example, after the “Time to start partial BF after T0”, both devices may begin to participate in the partial BF process using their stated/declared number of sectors and Rx antennas. If the partial SLS procedure succeeds, it may be followed by possibly another BF process (e.g., beamforming refinement) and then a data transfer.

On the other hand, if the partial SLS procedure fails (possibly several times depending on the corresponding timer values), after the “Time to start Full BF after TO”, both devices start the full BF, using the full-length sector sweep at both sides.

As described herein, aspects of the present disclosure provide a mechanism for devices to exchange a number of transmit sectors to be used for partial and full sector sweeps, effectively, defining two levels of sector sweep length for the link lost state. By exchanging timing information, the devices may also stay in synch when performing a partial sector sweep and when transitioning from a partial sector sweep to a full sector sweep.

### Examples of Fast Beamforming in Multi-Antenna RF Configurations

Currently, it is possible for both 802.11ad devices and 802.11 ay devices to establish a directed antenna link. When two such devices connect, they may first perform a TX sector level sweep (SLS) to establish a Control-PHY link and may perform additional actions to improve antenna directivity required for a Data-PHY link. When the link is degraded or lost, however, the devices may trigger beamforming to re-establish the link. For example, the devices may start with performing TX SLS again. Additionally, devices may trigger beamforming and attempt to re-establish the link when performance degrades, for example, when the devices experience a high packet error rate.

The TX SLS process involves traversing a list of pre-defined TX sectors and transmitting a special frame on each TX sector, which roughly translates to a physical direction. One device initiates the process and performs a TX sector sweep. The other device receives some of the frames and responds with its own TX sector sweep. Each device indicates to the other device which of the other device TX sectors was received with the highest quality measure.

The TX sector sweep process is relatively long. Further, its duration grows with the number of TX sectors as well as with the number of antennas used. For example, devices having multiple antennas operating in a diversity mode using a large number of TX sectors per antenna may require several milliseconds to complete the TX SLS.

Virtual Reality (VR), Augmented Reality (AR), and Docking may require very high throughput with very low latency. This is because, for example, when the platform is mobile the devices may change their relative position and orientation and trigger beam forming frequently. The long TX SLS flow may, therefore, interrupt the actual traffic being transmitted over the link. It can, therefore, be appreciated that the long TX SLS may introduce long latency and may degrade the user experience. For example, the video image may judder or freeze. As the required video frame rate per second (FPS) increases, the allowed end to end latency decreases. One or more of these considerations may be addressed by one or more of the described cases herein.

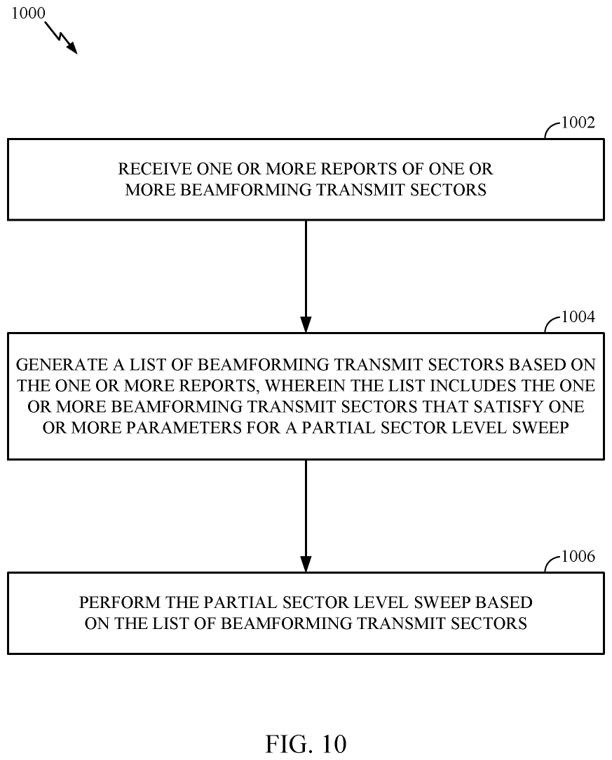

FIG. 10 illustrates example operations 1000 for performing beamforming training, in accordance with certain aspects of the present disclosure. Operations 1000 may be separately performed, for example, both by an initiator and a responder device.

Operations 1000 begin, at 1002, by receiving one or more reports of one or more beamforming transmit sectors. Operations 1000 further include, at 1004, generating a list of beamforming transmit sectors based on the one or more reports, wherein the list includes the one or more beamforming transmit sectors that satisfy one or more conditions related to one or more parameters for a partial sector level sweep. Operations 100 further include, at 1006, performing the partial sector level sweep based on the list of beamforming transmit sectors. In some cases, the one or more parameters include one or more of a signal to noise ratio (SNR), transmit (Tx) power, proximity, system characteristics, or feedback.

For example, in one or more cases, use of a short list of TX sectors may be provided. This list may be a subset of a much larger list of TX sectors and may be maintained dynamically relying on selected TX sectors candidates. For example, in some cases, an initial sector level sweep may be implemented to identify one or more best sectors which are sectors that meet one or more associated parameters for providing desired performance metrics for applications such as, for example, VR or AR processes. In some cases, after this initial sector level sweep, a list of best sectors may be stored, rather than a single best sector as was previously done.

In some cases, operations for extending the list may also be provided. For example, extending the list may be provided by adding sectors having spatial coverage that is near, adjacent to, partially-overlapping, or overlapping with spatial coverage of one or more of the beamforming transmit sectors in the list. For example, in accordance with one or more cases, for each sector on the ‘best sector’ list, an additional sub-list of associated sectors may be compiled. The associated sectors may be identified and selected based on a number of parameters. For example, the associated sectors may be selected are in accordance with their proximity to one or more member sectors of the ‘best-sector’ list.

In some cases, operations for consolidating or merging the extended list may be provided. For example, the extended list may be provided such that each sector is represented once by cancelling out recurring entries of sectors in the list. In some cases, operations for grading the sectors may be provided. For example, grading may be provided in the list based on the SNR reported by a receiver and relative TX sector gain. In some cases, operations for ordering the list may be provided. For example, ordering the list of sectors based on grade may be provided. The ordering may be provided by starting with high grade sectors that correspond to higher SNR. In some cases, operations may further include performing a partial sector level sweep using the ordered list of sectors. In some cases, operations may further include performing a full sector level sweep by transmitting one or more beamforming transmit frames on all beamforming transmit sectors.

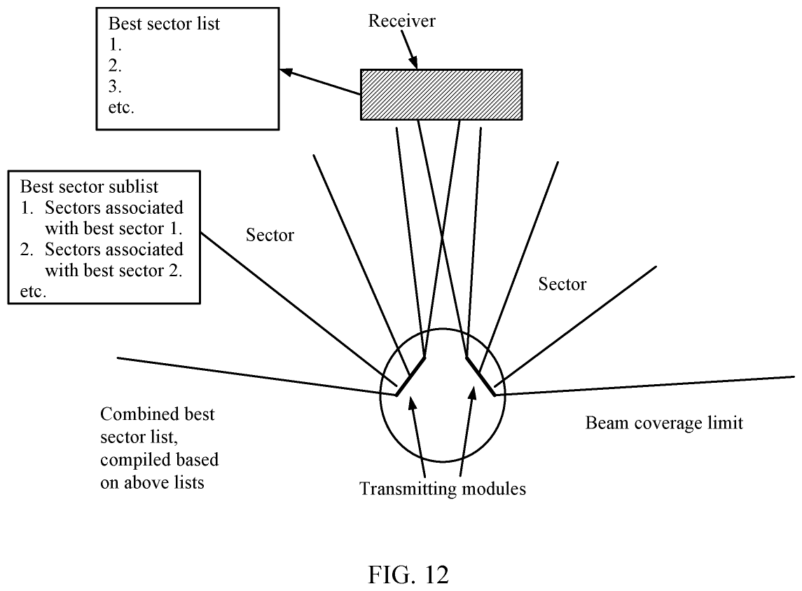

FIG. 12 illustrates an example of transmitting modules and a receiver, in accordance with certain aspects of the present disclosure. As shown in FIG. 12, in some cases, an initial sweep may be provided from a transmitter array that includes the transmitting modules to a receiver. Further, sectors may be identified that include a best signal to noise ratio. In such cases, at least two sectors may be identified, and in some cases a list of best sectors, that may be ranked according to signal to noise ratio (SNR). The list of sectors may then be provided by the receiver to the transmitter array. For each member of the ‘best sector’ list, the transmitter may provide a sub-list of associated sectors. The associated sectors may be included in the sub-list based on their proximity to the beam on the best sector list rather than on their individual characteristics.

As shown in FIG. 12, in some cases, an overlap between the members of the list of best sectors and the member of the associated sub-list may be evident. The overlap is overcome by cancelling out recurring members of the list, to produce a final list (for example 8 sectors) in which each sector only appears once. A number of different algorithms may be implemented in order to identify which sectors should be cancelled out.

In some cases, once a final list of best sectors and associated best sectors is compiled, this constitutes a sector map over which subsequent partial sweeps are performed, rather than doing a total sweep. In some cases, sectors may correspond to one antenna module or more than one antenna module. In some cases, sectors are not necessarily of equal size or symmetric.

In some cases, an antenna system may include an antenna array comprising a plurality of transmitting antenna elements transmitting radiation over a region, said region comprising multiple sectors. The antenna system may further comprise at least one receiver receiving said radiation transmitted by said antenna elements. In some cases, the receiver may be operable to identify two or more of said multiple sectors having at least one optimum beam characteristic. In some cases, only selected ones of said plurality of transmitting antenna elements radiating in said two or more multiple sectors may be activated following identification of said two or more of said multiple sectors. In some cases, a receiver may be operable to provide an output to an antenna array, where the output comprises a listing of two or more of the multiple sectors. The beam characteristic may include a signal to noise ratio.

In some cases, a map that includes one or more regions may be created in which one or more of the best sectors are shown in the regions where they are most likely to be present in a subsequent sweep. The selection of and performance of a subsequent sweep may be selected such that it is done only over a region in which a select best sector is indicated as being most likely to be present which, in some cases, may be much faster than a full SLS. Allowing subsequent sector sweeps to be performed only over such a region in which the best sector is likely to be found, rather than over a whole range of sectors, may therefore see a reduction in the time required to perform such a sweep. For example, in some cases using such a mapping may be 6 to 12 times faster than a non-optimized sweep.

In some cases, during a sector level sweep, rather than storing only the best sector, the device may store a list of best sectors, where the best sectors are defined as sectors that include a set of best beam characteristics. Currently, such a list is not stored but rather only a single best sector may be stored in contrast to the one or more cases as disclosed herein which may include, for example, storing several best sectors with best beam characteristics. In some cases, the list of ‘best sectors’ may be as long as desired, depending on how much time is to be saved in a subsequent sweep. Different members of the list are likely to overlap, leading to a final list of sectors that includes a fewer number of sectors than initially appeared to be on the ‘best-sector’ list and associated sector list.

In some cases, by sweeping a smaller region with only a few sectors there is a chance that the best sector may be found outside of the smaller region. Accordingly, sweeping a larger region with a greater number of sectors which takes longer may be provided where such a sweep may provide a better chance that the best sector can be found within the swept region. In some cases, operations may periodically perform a sweep over a larger number of sectors, in order to ensure that the best sector indeed lies within the swept region. In some cases, such operations may be performed sequentially, in order to narrow down region further and further.

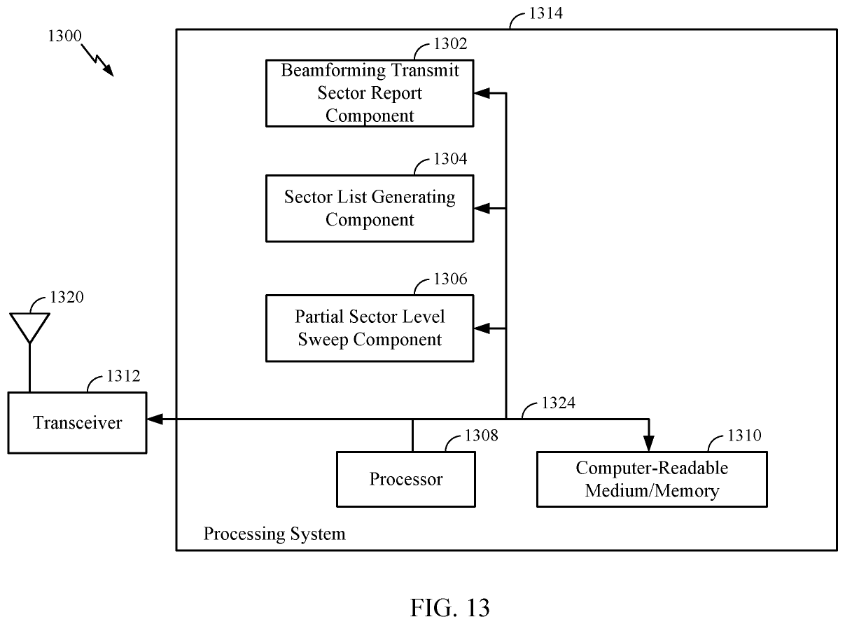

FIG. 13 illustrates a communications device 1300 that may include various components (e.g., corresponding to means-plus-function components) configured to perform operations for the techniques described herein, such as the operations 1000 illustrated in FIG. 10. The communications device 1300 includes a processing system 1314 coupled to a transceiver 1312. The transceiver 1312 is configured to transmit and receive signals for the communications device 1300 via an antenna 1320, such as the various signal described herein. The processing system 1314 may be configured to perform processing functions for the communications device 1300, including processing signals received and/or to be transmitted by the communications device 1300.

The processing system 1314 includes a processor 1308 coupled to a computer-readable medium/memory 1310 via a bus 1324. In certain aspects, the computer-readable medium/memory 1310 is configured to store instructions that when executed by processor 1308, cause the processor 1308 to perform the operations illustrated in FIG. 10, or other operations for performing the various techniques discussed herein. In certain aspects, the processing system 1314 further includes a beamforming transmit sector report component 1302 for performing the operations illustrated at 1002 in FIG. 10. The processing system 1314 also includes a sector list generating component 1304 for performing the operations illustrated at 1004 in FIG. 10. The processing system 1314 also includes a partial sector level sweep component 1306 for performing the operations illustrated at 1006 in FIG. 10.

The beamforming transmit sector report component 1302, sector list generating component 1304, and partial sector level sweep component 1306 may be coupled to the processor 1308 via bus 1324. In certain aspects, the beamforming transmit sector report component 1302, sector list generating component 1304, and partial sector level sweep component 1306 may be hardware circuits. In certain aspects, the beamforming transmit sector report component 1302, sector list generating component 1304, and partial sector level sweep component 1306 may be software components that are executed and run on processor 1308.

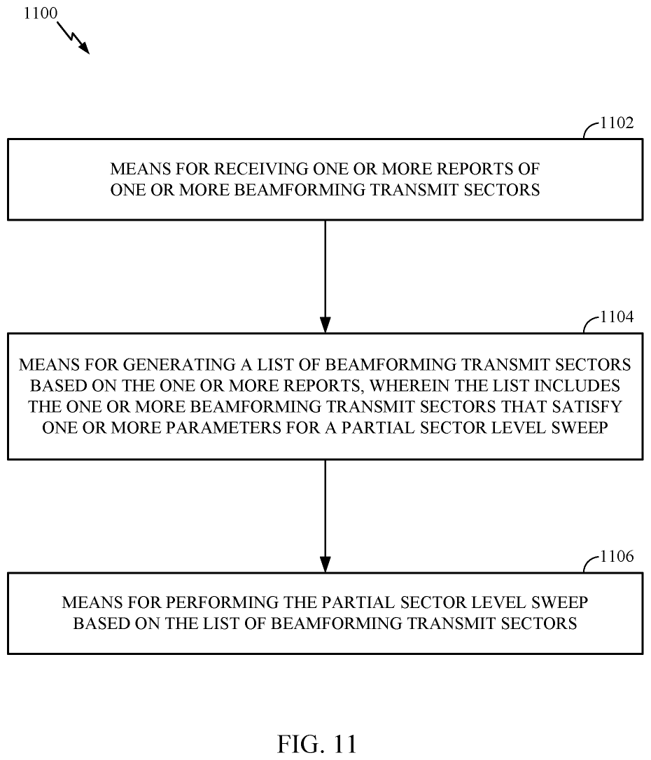

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 1000 illustrated in FIG. 10 correspond to means 1100 illustrated in FIG. 11, respectively.

For example, means for exchanging may comprise a transmitter (e.g., the transmitter unit 222) and/or an antenna(s) 224 of the access point 110 or the transmitter unit 254 and/or antenna(s) 252 of the user terminal 120 illustrated in FIG. 2 and/or a receiver (e.g., the receiver unit 222) and/or an antenna(s) 224 of the access point 110 or the receiver unit 254 and/or antenna(s) 254 of the user terminal 120 illustrated in FIG. 2. Additionally, means for generating, means for extending, means for cancelling, means for merging, means for grading, means for ordering, means for performing, and/or means for processing, may comprise a processing system, which may include one or more processors, such as the RX data processor 242, the TX data processor 210, the TX spatial processor 220, and/or the controller 230 of the access point 110 or the RX data processor 270, the TX data processor 288, the TX spatial processor 290, and/or the controller 280 of the user terminal 120 illustrated in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, and/or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1); a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communication by a network entity, comprising:
receiving one or more reports of one or more beamforming transmit sectors;
generating a list of beamforming transmit sectors based on the one or more reports, wherein the list includes the one or more beamforming transmit sectors that satisfy one or more conditions related to one or more parameters for a partial sector level sweep; and
performing the partial sector level sweep based on the list of beamforming transmit sectors.

2. The method of claim 1, wherein the one or more parameters include one or more of a signal to noise ratio (SNR) associated with a beamforming transmit sector, a transmit (Tx) power of the network entity, a proximity of a beamforming transmit sector to a receiver, system characteristics of the network entity, or feedback from the receiver.

3. The method of claim 1, further comprising:
extending the list by adding sectors having spatial coverage that is near, adjacent to, partially-overlapping, or overlapping with spatial coverage of one or more of the beamforming transmit sectors in the list.

4. The method of claim 3, further comprising:
cancelling out recurring entries of sectors in the extended list.

5. The method of claim 1, further comprising:
grading the sectors in the list based on a signal to noise ratio (SNR) reported by a receiver and a sector gain.

6. The method of claim 5, further comprising:
ordering the list of sectors based on grade, starting with high grade sectors that correspond to higher SNR.

7. The method of claim 6, wherein the performing the partial sector level sweep is based on the ordered list of sectors.

8. The method of claim 1, further comprising:
performing a full sector level sweep by transmitting one or more beamforming transmit frames on all beamforming transmit sectors.

9. An apparatus for wireless communication by a network entity, comprising:
means for receiving one or more reports of one or more beamforming transmit sectors;
means for generating a list of beamforming transmit sectors based on the one or more reports, wherein the list includes the one or more beamforming transmit sectors that satisfy one or more conditions related to one or more parameters for a partial sector level sweep; and
means for performing the partial sector level sweep based on the list of beamforming transmit sectors.

10. The apparatus of claim 9, wherein the one or more parameters include one or more of a signal to noise ratio (SNR) associated with a beamforming transmit sector, a transmit (Tx) power of the network entity, a proximity of a beamforming transmit sector to a receiver, system characteristics of the network entity, or feedback from the receiver.

11. The apparatus of claim 9, further comprising:
means for extending the list by adding sectors having spatial coverage that is near, adjacent to, partially-overlapping, or overlapping with spatial coverage of one or more of the beamforming transmit sectors in the list.

12. The apparatus of claim 11, further comprising:
means for cancelling out recurring entries of sectors in the extended list.

13. The apparatus of claim 9, further comprising:
means for grading the sectors in the list based on a signal to noise ratio (SNR) reported by a receiver and a sector gain.

14. The apparatus of claim 13, further comprising:
means for ordering the list of sectors based on grade, starting with high grade sectors that correspond to higher SNR.

15. The apparatus of claim 14, wherein the means for performing the partial sector level sweep is based on the ordered list of sectors.

16. The apparatus of claim 9, further comprising:
means for performing a full sector level sweep by transmitting one or more beamforming transmit frames on all beamforming transmit sectors.

17. An apparatus for wireless communication by a network entity, comprising:
a receiver configured to receive one or more reports of one or more beamforming transmit sectors;
at least one processor configured to:
generate a list of beamforming transmit sectors based on the one or more reports, wherein the list includes the one or more beamforming transmit sectors that satisfy one or more conditions related to one or more parameters for a partial sector level sweep; and
perform the partial sector level sweep based on the list of beamforming transmit sectors; and
a memory coupled to the at least one processor.

18. The apparatus of claim 17, wherein the one or more parameters include one or more of a signal to noise ratio (SNR) associated with a beamforming transmit sector, a transmit (Tx) power of the network entity, a proximity of a beamforming transmit sector to a receiver, system characteristics of the network entity, or feedback from the receiver.

19. The apparatus of claim 17, wherein the at least one processor is configured to:
extend the list by adding sectors having spatial coverage that is near, adjacent to, partially-overlapping, or overlapping with spatial coverage of one or more of the beamforming transmit sectors in the list.

20. The apparatus of claim 19, wherein the at least one processor is configured to:
cancel out recurring entries of sectors in the extended list.

21. The apparatus of claim 17, wherein the at least one processor is configured to:
grade the sectors in the list based on a signal to noise ratio (SNR) reported by a receiver and a sector gain.

22. The apparatus of claim 21, wherein the at least one processor is configured to:
order the list of sectors based on grade, starting with high grade sectors that correspond to higher SNR.

23. The apparatus of claim 22, wherein the at least one processor is configured to perform the partial sector level sweep based on the ordered list of sectors.

24. The apparatus of claim 17, wherein the at least one processor is configured to:
perform a full sector level sweep by transmitting one or more beamforming transmit frames on all beamforming transmit sectors.

25. A non-transitory computer readable medium for wireless communication by a network entity having instructions stored thereon for:
receiving one or more reports of one or more beamforming transmit sectors;
generating a list of beamforming transmit sectors based on the one or more reports, wherein the list includes the one or more beamforming transmit sectors that satisfy one or more conditions related to one or more parameters for a partial sector level sweep; and
performing the partial sector level sweep based on the list of beamforming transmit sectors.

26. The non-transitory computer readable medium of claim 25, wherein the one or more parameters include one or more of a signal to noise ratio (SNR) associated with a beamforming transmit sector, a transmit (Tx) power of the network entity, a proximity of a beamforming transmit sector to a receiver, system characteristics of the network entity, or feedback from the receiver.

27. The non-transitory computer readable medium of claim 25, further comprising instructions stored thereon for:
extending the list by adding sectors having spatial coverage that is near, adjacent to, partially-overlapping, or overlapping with spatial coverage of one or more of the beamforming transmit sectors in the list.

28. The non-transitory computer readable medium of claim 27, further comprising instructions stored thereon for:
cancelling out recurring entries of sectors in the extended list.

29. The non-transitory computer readable medium of claim 25, further comprising instructions stored thereon for:
grading the sectors in the list based on a signal to noise ratio (SNR) reported by a receiver and a sector gain; and
ordering the list of sectors based on grade, starting with high grade sectors that correspond to higher SNR,
wherein the performing the partial sector level sweep is based on the ordered list of sectors.

30. The non-transitory computer readable medium of claim 25, further comprising instructions stored thereon for:
performing a full sector level sweep by transmitting one or more beamforming transmit frames on all beamforming transmit sectors.
